(19) United States
(12) Patent Application Publication
(10) Pub. No.: US 2023/0380474 A1
(43) Pub. Date: Nov. 30, 2023

(54) Automated Burrito Maker

(71) Applicant: CARGILL, INCORPORATED, Wayzata, MN (US)

(72) Inventors: Sarah Elizabeth Bielby, Cambridgeshire (GB); Stuart John DUNLOP, Royston (GB); Alasdair David MacBean; Grant West, Bedfordshire (GB); Philip Leslie Wood, Essex (GB)

(73) Assignee: Cargill, Incorporated, Wayzata, MN (US)

(21) Appl. No.: 18/249,681

(22) PCT Filed: Oct. 20, 2021
(86) PCT No.: PCT/US2021/055807

§ 371 Date: Apr. 19, 2023

Related U.S. Application Data
(60) Provisional application No. 63/094,287, filed on Oct. 20, 2020.

(51) Int. Cl. A23P 20/20

(52) U.S. Cl. CPC A23P 20/20

(57) ABSTRACT

An automated burrito maker is described, including a filling station for providing a quantity of burrito filling on an upper surface of tortillas on a first belt, an air supply positioned below a gap between the first belt and a second belt for delivering an air blast to lift a leading edge of each tortilla moving over the gap, a front fold station for crimping the leading edge of the tortilla toward the upper tortilla surface and around at least a portion of the burrito filling, a first side fold station having a first folding rail for wrapping the first tortilla side over at least a portion of the burrito filling, and a second side fold station having a second folding rail for wrapping the second tortilla side over at least a portion of the burrito filling and at least a portion of the first side of the tortilla.

### CROSS REFERENCE TO RELATED APPLICATIONS

This application claims the benefit of U.S. Provisional Patent Application No. 63/094,287, filed 20 Oct. 2021, which is hereby incorporated by reference in its entirety.

### TECHNICAL FIELD

The present disclosure generally relates to automated food processing methods and apparatuses, and more particularly relates to methods and apparatuses for preparing folded burrito or burrito-type products.

### BACKGROUND

Burritos are popular food items that have been available for many years from fast food restaurants, and are often intended for consumption during the lunch and dinner hours. Such burritos are traditionally assembled on-site by an employee who places a filling of items such as meat, beans, cheese, lettuce, and other toppings on a flat tortilla, and then physically folds the sides and/or end(s) of the tortilla toward its center to enclose the toppings and provide an easy-to-eat food item. In recent years, some fast food restaurants have expanded their services to also include a breakfast menu with items such as breakfast burritos. Unlike the more typical lunch and dinner burritos, breakfast burritos typically include eggs and breakfast sausage, along with items such as cheese and vegetables.

While breakfast burrito ingredients can have different consistencies from lunch and dinner burrito ingredients, the on-site physical assembly of all these burritos is generally the same. However, because employees are often trying to quickly accomplish a number of simultaneous tasks to complete a customer's order, there can be significant labor and quality control issues encountered with the on-site manual filling and folding of the tortillas. In order to eliminate the issues that can result from consumers receiving inconsistent products, and in order to reduce the demand on restaurant employees, there is a desire to provide an automated process for off-site completed burritos that are prepared and supplied to the restaurant. Once an order is received from a customer, the only step to be completed at the restaurant is to heat the burrito on-site. It is further desired that such an automated burrito making process maximizes the number of burritos made in a defined time period without sacrificing product quality.

### SUMMARY

The automated burrito making processes described herein generally include providing a stack of tortillas to a tortilla dispensing station (not shown) from which tortillas are picked up from a stack and placed on a moving belt. As the tortillas are conveyed in a machine direction, a patty or dose of burrito filling is positioned onto each tortilla, which is folded around the burrito filling. The completed burrito can then be frozen and/or wrapped or packaged as desired.

In one aspect of this disclosure, an embodiment of an automated burrito maker is described for forming burritos from a flexible tortilla comprising an upper surface, a leading edge, a trailing edge, a first side, and a second side. The automated burrito maker comprises a filling station for providing a quantity of burrito filling on the upper surface of the tortillas, the filling station comprising a first generally horizontal belt having an upper surface for conveying tortillas in a machine direction, an air blast station comprising a second generally horizontal belt that is spaced by a gap from the first horizontal belt, and an air supply positioned below the gap for delivering an air blast to lift the leading edge of each tortilla as each tortilla is conveyed in the machine direction from the first horizontal belt toward the second horizontal belt and over the gap, a front fold station comprising upper rollers and crimping rails for crimping the leading edge of the tortilla toward the upper tortilla surface and around at least a portion of the burrito filling, a first side fold station comprising a first folding rail for guiding the first side of the tortilla to wrap over at least a portion of the burrito filling, and a second side fold station comprising a second folding rail for guiding the second side of the tortilla to wrap over at least a portion of the burrito filling and at least a portion of the first side of the tortilla.

The filling station of this embodiment of a burrito maker includes an angled conveyor positioned above the horizontal belt for moving the quantity of burrito filling toward the upper surface of the tortillas. The quantity of burrito filling may be provided as multiple discrete blocks that each comprise multiple burrito ingredients, wherein one or more of the ingredients may be a binding agent. The discrete blocks may be formed in a block-forming station in which the burrito ingredients are subjected to sufficient pressure to form discrete blocks during the application of pressure. The burrito maker may include a freezing station after the block-forming station for freezing the discrete blocks after the pressure is removed. The air supply may include a plurality of air jets spaced from each other in a direction transverse to the machine direction. The burrito maker may include a plurality of rollers vertically spaced from the second horizontal belt after the air blast station, wherein the lifted leading edge of each tortilla will contact the plurality of rollers as it moves from the air blast station toward the front fold station. At least one of the first folding rail and the second folding rail are curved from one side of the second horizontal belt toward the opposite side of the second horizontal belt. The angled conveyor and the first horizontal belt are synchronized for precise depositing of the burrito filling on a predetermined location of the upper surface of each tortilla.

In another aspect of this disclosure, a method is described for forming burritos using an automated burrito maker. The method includes the steps of placing a flexible tortilla on an upper surface of a first conveyor, wherein each tortilla comprises an upper surface, a leading edge, a trailing edge, a first side, and a second side, conveying each tortilla in a machine direction to a filling station, placing a quantity of burrito filling on the upper surface of each tortilla, conveying each tortilla toward an air blast station that comprises a second conveyor that is spaced by a gap from the first conveyor, and an air supply positioned below the gap, delivering an air blast to lift the leading edge of each tortilla as each tortilla is conveyed in the machine direction from the first conveyor toward the second conveyor and over the gap, conveying each tortilla to a front fold station comprising upper rollers and crimping rails, crimping the leading edge of each tortilla toward the upper tortilla surface and around at least a portion of the burrito filling, conveying each tortilla to a first side fold station comprising a first folding rail, guiding the first side of each tortilla over at least a portion of the burrito filling, conveying each tortilla to a second side fold station comprising a second folding rail, and guiding the second side of the tortilla over at least a portion of the burrito filling and at least a portion of the first side of the tortilla.

The filling station used in the burrito forming method may include an angled conveyor positioned above the horizontal belt so that the angled conveyor moves the quantity of burrito filling toward the upper surface of each tortilla. The step of placing a quantity of burrito filling on each tortilla may include providing the quantities of burrito filling in discrete blocks that each comprise multiple burrito ingredients, wherein the multiple burrito ingredients may include a binding agent.

The burrito forming method may further include a step of forming the quantities of burrito filling into discrete blocks before the step of placing the burrito filling on the upper surface of each tortilla by subjecting the quantities of burritos to sufficient pressure to form discrete blocks, and may also include a step of freezing the discrete blocks at a freezing station after the pressure is removed.

The step of delivering an air blast may include providing an air blast from a plurality of air jets spaced from each other in a direction transverse to the machine direction. In an aspect, the tortilla is heated prior to delivering the air blast. The burrito maker may include a plurality of rollers vertically spaced from the second horizontal belt after the air blast station so that the lifted leading edge of each tortilla contacts the plurality of rollers as it moves from the air blast station toward the front fold station. The first folding rail and the second folding rail may be curved from one side of the second horizontal belt toward the opposite side of the second horizontal belt. In addition, the angled conveyor and the first horizontal belt may be synchronized for precise depositing of the burrito filling on a predetermined location of the upper surface of each tortilla.

While the present disclosure may specifically describe the invention in the context of a burrito, e.g., a method for a burrito from a tortilla and burrito filling ingredients, it is to be understood that the present disclosure is not intended to be specific to burritos, and any description, embodiment, and/or aspect related to burritos and the formation of burritos can also apply to any wrap-type food product made from a flexible wrap and any type of filling ingredients suitable for such a wrap-type food product.

### BRIEF DESCRIPTION OF THE DRAWINGS

The present invention will be further described with reference to the appended Figures, wherein like structure is referred to by like numerals throughout the several views, and wherein;

FIG. 1 is a top view of a portion of an embodiment of an automated burrito maker where burrito filling is deposited onto tortilla shells, as viewed from the front of the process;

FIG. 2 is a perspective view of the portion of the automated burrito maker illustrated in FIG. 1, as viewed from one side of the equipment;

FIG. 3 is a side view of the portion of an automated burrito maker illustrated in FIGS. 1-2;

FIG. 4 is a top view of the portion of an automated burrito maker illustrated in FIGS. 1-3;

FIG. 5 is a side view of a portion of an embodiment of an automated burrito maker where a front fold of each tortilla is initiated, including a gap between two horizontal belts under which an air supply is positioned;

FIG. 6 is a top view of the portion of an automated burrito maker illustrated in FIG. 5;

FIG. 7 is a perspective view of the portion of an automated burrito maker illustrated in FIGS. 5-6;

FIG. 8 is a perspective view of a portion of an automated burrito maker including three stations for folding of a tortilla around burrito filling;

FIG. 9 is a side view of the portion of an automated burrito maker illustrated in FIG. 8;

FIG. 10 is a top view of the portion of an automated burrito maker illustrated in FIGS. 8-9;

FIG. 11 is a side view of a portion of an automated burrito maker where crimping of the tortillas and completing the front fold of the tortillas takes place;

FIG. 12 is a top perspective view of a portion of an automated burrito maker where a side fold of a first side of the tortilla is completed and where the start of the folding of a second side of the tortilla takes place;

FIG. 13 is a front top view of a portion of an automated burrito maker where a side fold of a second side of the tortillas takes place;

FIG. 14 is a top front view of a completed burrito as positioned between rails of a portion of an automated burrito maker;

FIG. 15 is a side perspective view of another embodiment of an automated burrito maker;

FIG. 15;

FIG. 16 is an enlarged view of a portion of the automated burrito maker of FIG. 17 is an enlarged view of another portion of the automated burrito maker of FIG. 15; and

FIG. 18 is a perspective view of a portion of another embodiment of an automated burrito maker.

### DETAILED DESCRIPTION

The present disclosure is directed to the automated making or assembly of burritos using equipment and processes that produce high quality products at high speeds. In an exemplary embodiment, the equipment and processes described herein allow for the production of approximately 700 burritos per minute. Such burritos can include breakfast burritos with ingredients such as eggs, meat, and/or cheese, or lunch or dinner burritos with ingredients such as meat, cheese, beans, and/or vegetables. The processes described herein can be equally adaptable to these or any other ingredients that are to be enclosed in a tortilla that is wrapped into a burrito configuration. It is further understood that while the description herein refers generally to the making of burritos, the equipment and methods described herein can also refer to other wrap-style food products that involve a flexible wrap material that is not a tortilla and/or can include ingredients that are not typically included in a burrito. For example, the flexible wrap material can include items such as seaweed, lettuce, pita bread, and the like.

In aspects of the processes and equipment described herein, a food product mixture (also referred to herein as “burrito filling”) is made into discrete patties or blocks that will comprise the filling for a burrito. This can be accomplished in a number of ways, wherein one process includes the steps of feeding loose ingredients through a hopper or other input device to a patty-making device (not shown), portioning the loose ingredients into measured doses, and compressing and/or otherwise forming the doses of ingredients to form a solid or semi-solid patty or block. In an aspect, the burrito filling may also include one or more binding agents that help the various loose ingredients to “stick” or bind to each other in a patty or block. In an aspect, the binding agent may be a cheese sauce, a starch, a gum, a protein composition (for example but not limited to whole egg, egg whites, and solutions or mixtures of proteins such as soy or whey protein in water), and mixtures or combinations thereof. In an aspect, the binding agent can be any food-grade composition useful for holding together the burrito filling ingredients in discrete portions. The use of such binding agents can also provide a base in which relatively large, discrete ingredients can hold their shape because they will not be crushed or compressed during the process of forming the patties or blocks.

In one more specific exemplary embodiment, a mixture of loose ingredients, which may be fresh or frozen, are supplied to a machine's hopper and fed via a servo feed screw or electric motor into a pneumatic double pump. The mixture is shaped into patties, blocks, strips, or otherwise discrete single-sized portions on a rotary drum, where the shape of the patties generally matches the desired shape that the ingredients will take when enclosed within a tortilla (e.g., a generally elongated cylindrical shape). A rotary knock-out system then drops the patties onto a conveyor belt that carries the patties from the machine. In cases where the mixture includes egg products, the mixture may include added ingredients that improve adhesion of the mixture within a patty. The amount of pressure to which the products are subjected should be sufficient to hold the products together in a desired shape and size, but not so high that it detrimentally impacts the ingredients and/or results in an end product that is too dense to provide a pleasant consumer experience.

In an aspect, the temperature of the burrito filling ingredients can be adjusted prior to the ingredients being formed into discrete portions and/or compressed. In an aspect, the burrito filling ingredients are adjusted to and/or maintained at temperature of 20 to 32° F.; 20 to 30° F.; 22 to 30° F.; 24 to 30° F.; 24 to 28° F., 25 to 27° F.; 25 to 28° F.; 25 to 30° F.; 26° F. or about 26° F. during the block-forming step. In an aspect, the burrito filling ingredients are maintained at a temperature below freezing temperature during the block-forming step. i.e., the step in the block-forming station in which the burrito ingredients are subjected to sufficient pressure to form discrete blocks.

Another method of producing the patties may alternatively or additionally involve providing ingredients to a hopper or other input device to a machine that presses or otherwise forms the ingredients into a continuous sheet or discrete sheets that are conveyed toward an optional freezer. When a freezer is provided, the sheets of compressed ingredients are conveyed through the freezer for an appropriate length of time until the ingredients are at least partially frozen. Whether the sheets are frozen or not, they can then be cut into patties or blocks as they continue to be conveyed from the machine that compressed the ingredients. These patties or blocks may be shaped the same or differently from the patties described above in that the patties or blocks formed by this process also generally have the desired shape that the ingredients will take when enclosed within a tortilla.

While the processes and equipment described below will generally refer to patties that are positioned in a tortilla, it is understood that the ingredients may instead be provided as doses of loose ingredients or measured and delivered in another manner. Both processes will be generally the same; however, if loose ingredients are dispensed onto a tortilla, different equipment will be provided to dose the ingredients into proper serving amounts, and extra guides may be required to direct the ingredients and confine them to their desired location relative to a tortilla.

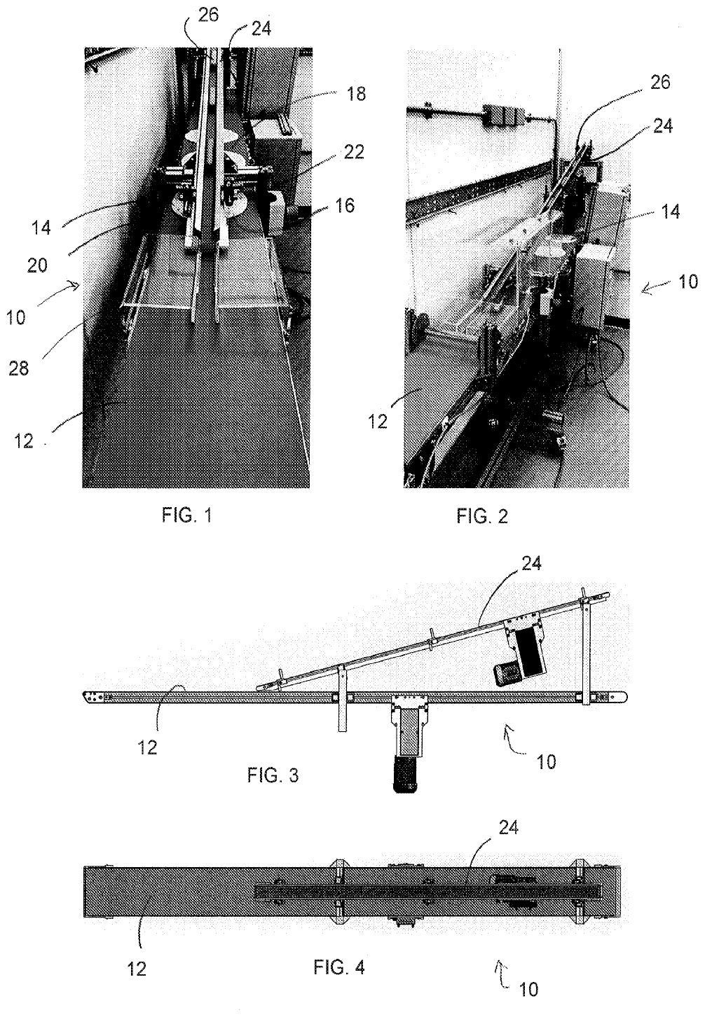

Referring now to the Figures, wherein the components are labeled with like numerals throughout the several Figures, and initially to FIGS. 1-4, a first station 10 of an exemplary embodiment of an automated burrito maker is illustrated. First station 10 includes a first belt 12 that is generally horizontal and sized to accommodate a variety of sizes of tortillas 14. Individual tortillas 14 are placed on an upper surface of the first horizontal belt 12 by any type of tortilla supply mechanism or process, which may include automatic devices, semi-automatic devices, and/or manual tortilla placement. Tortillas 14 are shown as having a generally circular outer shape, although it is understood that the tortillas can have a shape that is at least slightly different from a circle. In any case, the front or first edge of each tortilla 14 that enters the first station 10 is referred to as a leading edge 16, the edge that is opposite the leading edge 16 is referred to as a trailing edge 18, and the edges that run between the leading edge 16 and trailing edge 18 are referred to as a first side 20 and a second side 22. When moving along the first horizontal belt 12, adjacent tortillas 14 will typically have at least a small space between a trailing edge 18 of one tortilla 14 and a leading edge 16 of an adjacent tortilla 14, although it is possible that adjacent tortillas 14 are touching each other or that at least some tortillas 14 partially overlap adjacent tortillas 14.

The first station 10 further includes a conveyor 24 angled downwardly toward the first horizontal belt 12 relative to the direction the horizontal belt 12 is moving. In one example, the conveyor 24 is angled at approximately 15 degrees relative to the first horizontal belt 12, although the angle can be greater or less than 15 degrees. It is possible for the conveyor 24 to be adjustable to provide the ability to change the angle between the conveyor 24 and the first horizontal belt 12.

Conveyor 24 includes optional outer rails between which a belt or other conveying mechanism can move patties of burrito filling 26 in a controlled manner. That is, the optional outer rails can ensure that the patties 26 stay aligned until they are placed on the tortillas 14. In general, the first horizontal belt 12 is driven at a speed that is synchronized with the speed at which the conveyer 24 moves the patties 26 so that the patties are placed in a desired location relative to each tortilla 14. The first station 10 may include one or more detectors (not shown) that locate the exact position of each tortilla 14 as it moves toward the end of the conveyor 24 from which the patties 26 exit. For example, one or more optical sensors can be used to locate the leading edge 16 of a tortilla 14, such as by detecting the difference in color between the tortilla and the belt 12, and then the speed at which the patties move along the conveyor can be controlled to place each patty 26 in a desired location relative to the detected leading edge.

The deposit location of each patty 26 relative to the leading and trailing edges 16, 18 of the tortilla 14 onto which it will be positioned can generally be managed through control of the belt of the conveyor 24, and can optionally also be managed using an intermediate belt to accelerate and/or decelerate the patties 26 when necessary. Lateral alignment of the patties 26 can be achieved using optional side rails 28 positioned beyond the end of the conveyor 24 to adjust the position of the patties 26 relative to the first and second sides 20, 22 of the tortilla 14. It is also contemplated that the patties 26 are laterally aligned using different methods and/or equipment than the illustrated optional side rails 28.

Although the above discussion describes one manner of depositing patties onto tortillas, a number of different methods for depositing patties or blocks of burrito filling are possible. For example, the patties are shown and described herein as having a generally longitudinal axis along their lengths and are positioned so that their longitudinal axes extend generally along the longitudinal or travel direction of the conveyor on which their corresponding tortillas are positioned. However, the patties may instead be positioned so that their longitudinal axes are generally perpendicular or transverse to the longitudinal or travel direction of the conveyor on which their corresponding tortillas are positioned. In other examples, the patties can be delivered or deposited onto tortillas using robotic arms for patty placement, via a vertical chute that shoots or projects individual patties in desired locations, via two or more alternating belts that are angled or otherwise configured, and/or other methods.

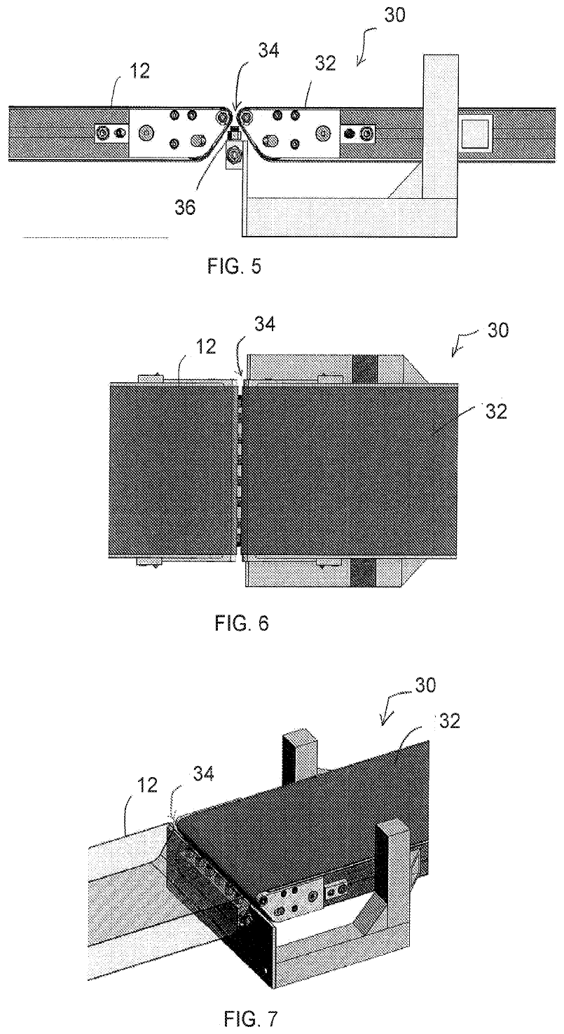

Referring to FIGS. 5-7, after a patty or block of burrito filling is placed on a tortilla, the combination product will continue to move along the first horizontal belt 12 toward a second station 30 where the leading edge 16 of the tortilla 14 will be folded back on itself and over at least a portion of the pre-placed patty. The second station 30 includes a second generally horizontal belt 32 that is spaced by a gap 34 from the first horizontal belt 12, along with an air supply 36 positioned below the gap 34. The air supply 36 can include multiple jets spaced along the width of the tortilla 14, or can include a single, transversely-positioned air jet.

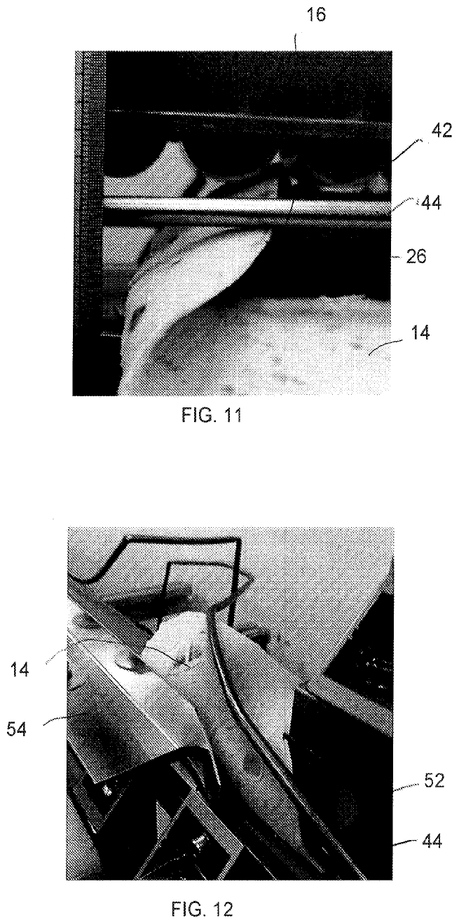

Both of the first and second horizontal belts 12, 32 can optionally include low radius “tails” at their adjacent ends to facilitate easy movement of the combination product from the first horizontal belt 12 onto the second horizontal belt 32. As the tortilla 14 is moved toward the second horizontal belt 32, a sensor (e.g., an optical sensor) detects the tortilla leading edge 16 and triggers an air blast from the air supply or jet 36 beneath the tortilla 14. This air blast lifts the tortilla leading edge 16 before it reaches a folding unit or horizontal roller rail that is positioned above the conveyor by a predetermined distance (e.g., see roller rails 42 illustrated in FIG. 11 and described below). This roller rail arrangement can include one or more idler rollers that facilitate a front fold and keep the leading edge 16 folded back over the burrito filling and toward the trailing edge 18. The pressure and duration of the air blast can be selected depending on a number of variables, such as the speed of the first and second horizontal belts 12, 32 and the size and thickness of the tortilla 14, for example. An optional roller positioned before the gap 34 ensures the burrito filling patty is held down during the air blast and allows a tighter leading edge fold of the tortilla around the patty.

It is desirable for the folding unit or roller rails 42 to have edges that extend along a generally horizontal plane to prevent misalignment of the leading edge fold. The air-blast pressure and duration, and the set-back or distance between air-blast gap 34 and the folding unit or horizontal roller rails can be configured to accommodate a range of conveyor speeds.

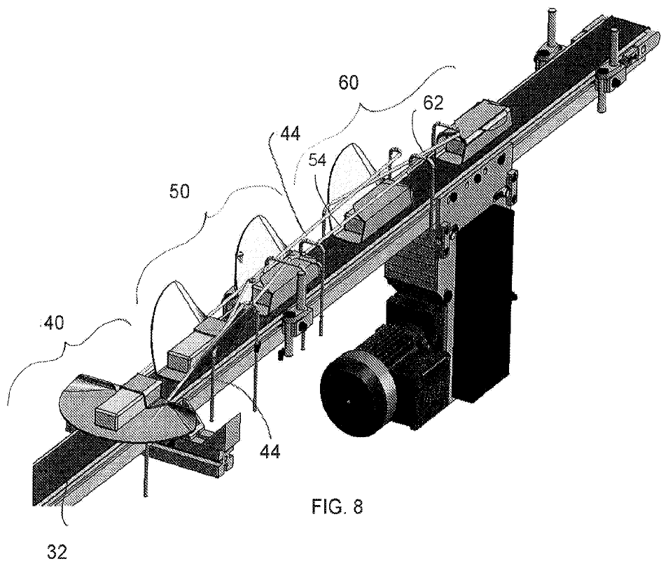

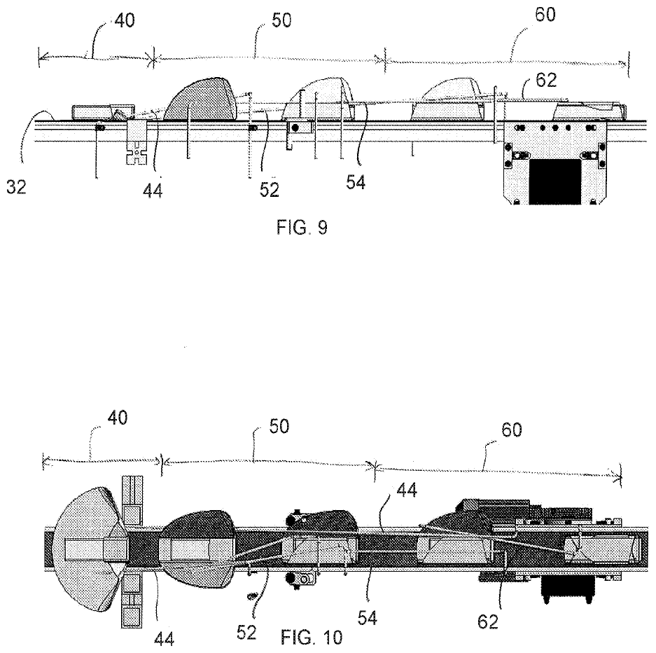

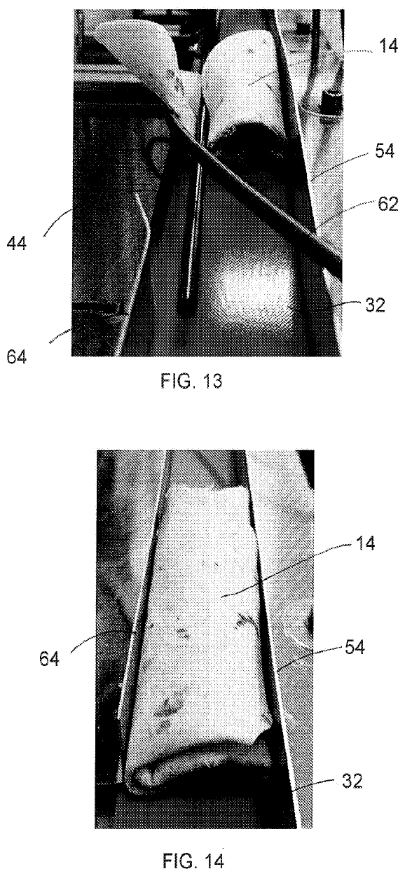

Referring now to FIGS. 8-14, each tortilla 14 will continue to move from second station 30 along second horizontal belt 32 toward a series of tortilla fold stations (i.e., a front fold station 40, a first side fold station 50, and a second side fold station 60 shown in the figures). These tortilla fold stations include a series of rollers and guide rails positioned around a narrow conveyor to perform the tortilla folds that further wrap each tortilla 14 around its respective burrito filling patty 26, as is described below in further detail.

The front fold station 40 includes rollers 42 and one or more crimping rails 44. In operation, the leading edge 16 of the tortilla 14, which has been curved upwards and back toward its trailing edge 18, will be held or pressed toward the patty 26 by rollers 42 that are most clearly visible in FIG. 11. The crimping rails 44 extend generally in the longitudinal direction of the horizontal belt 32 and are located so that as the tortilla 14 continues to move along the second horizontal belt 32, its leading edge 16 will contact the crimping rails 44 that will basically crimp the folded leading edge 16 of the tortilla around both sides of the patty 26 and toward the top surface of the tortilla 14.

The crimping rails 44 can be used in this station and throughout other stations of the burrito maker to continue crimping during each fold, which can prevent lateral folding forces that would allow misalignment of the burrito. In an exemplary embodiment, the crimping rails 44 are spaced at a distance from the top of second horizontal belt 32 to contact the tortilla for a desired amount of crimping or pressing of the tortilla toward the horizontal belt 32. The upper rollers 42 can be spaced from the top of second horizontal belt 32 by a distance that allows the rollers 42 to provide sufficient downward force to increase friction between the tortilla 14 and horizontal belt 32. Further, the side rails can be spaced by a distance above the horizontal belt 32 that minimizes or prevents slippage of the tortilla 14 under them so that they become jammed. The crimping rails 44 are preferably rigidly mounted for repeatability and to prevent misalignment. The crimping rails 44 continue crimping during each fold to prevent lateral folding forces misaligning the burrito.

The first side fold station 50 includes a first folding rail 52 and a first side rail 54 that can have a gentle taper so that it will be in contact with the entire length of a tortilla 14 as it continues to move along second horizontal belt 32. In an exemplary embodiment, the first side rail 54 (shown most clearly in FIG. 12, for example) is 33 mm high and offset towards the center approximately 1 mm from the edge of the horizontal belt 32. A first end of the first side rail 54 may optionally include a curved lead-in portion to further ease the transition of the tortilla 14 from its flat condition to its folded condition.

As the first side 20 of tortilla 14 moves along horizontal belt 32, it contacts the first folding rail 52, which initially picks up the first side 20 of tortilla 14 from horizontal belt 32. As the tortilla 14 continues to moves along the belt 32, the folding rail 52 will push its first side 20 toward the center of tortilla 14 and over at least a portion of the patty 26.

The second side fold station 60 includes a second folding rail 62 and a second side rail 64 that can have a gentle taper so that it will be in contact with the entire length of a tortilla 14 as it continues to move along second horizontal belt 32. A first end of the second side rail 64 may optionally include a curved lead-in to further ease the transition of the tortilla 14 from its flat condition to its folded condition.

As the second side 22 of tortilla 14 moves along horizontal belt 32, it contacts the second folding rail 62, which initially picks up the second side 22 of tortilla 14 from horizontal belt 32. As the tortilla 14 continues to moves along the belt 32, the second folding rail 62 will push second side 22 of tortilla 14 toward the center of tortilla 14 and over at least a portion of the patty 26. Second side 22 will typically also overlap at least a portion of the first side 20 that has already been folded or wrapped over the patty 26.

As shown in FIG. 14, after the tortilla 14 is wrapped around the burrito filling to complete the assembled burrito, the burrito will be moved along the horizontal belt 32 to a position that includes the first side rail 54 on one side of the burrito and the second side rail 64 on the opposite side of the burrito. In an embodiment, the first and second side rails 54, 64 are approximately 51 mm apart and approximately 33 mm high, although these dimensions can be different, depending on the size of the burrito. In any case, the first and second side rails 54, 64 are generally positioned to be able to hold the folds tight and keep the burrito filling securely wrapped within the tortilla 14.

Throughout the various tortilla folding stations discussed above, it can be advantageous to hold the burrito down (except for the moment when the tortilla side is folded over the top where this is not possible). Rollers can be positioned above the burrito throughout the folding process to provide downward pressure on the burrito for sufficient tortilla-to-belt friction. In an aspect, the tortilla may be heated prior to or during folding to improve the folding process. Accordingly, the automated burrito maker 100 may include one or more heating apparatuses for heating the tortillas prior to entering the various folding stations discussed above and/or for heating the tortillas after the tortillas enter a folding station.

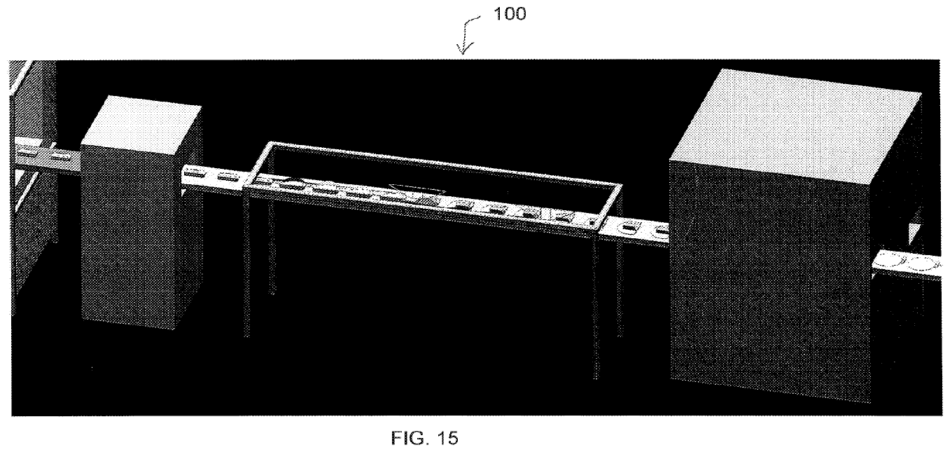

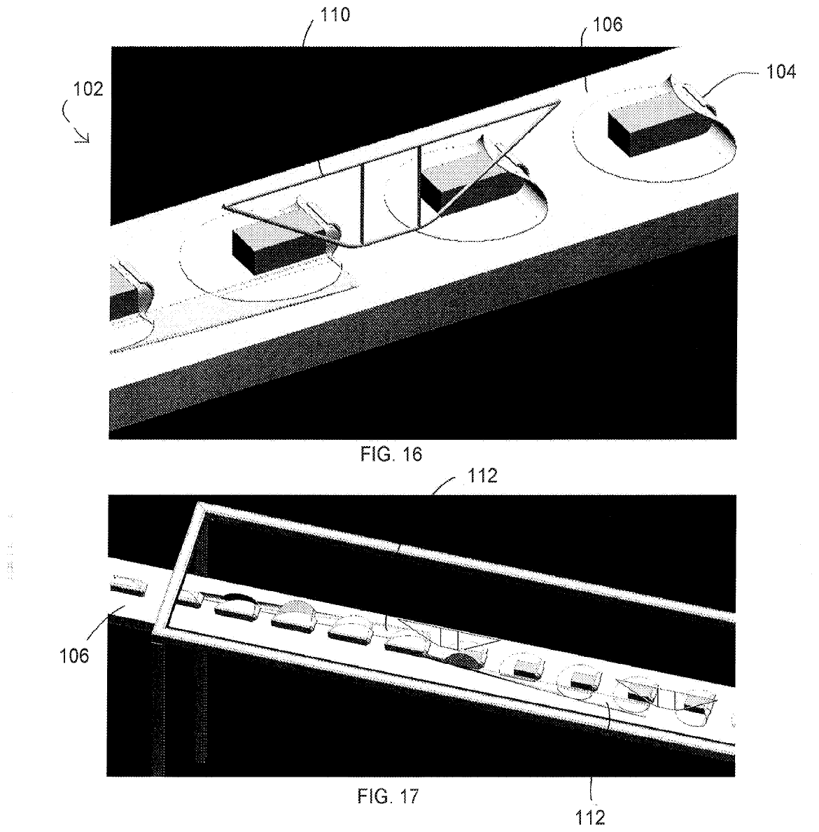

Another aspect of an automated burrito maker 100 is illustrated in FIGS. 15-17, which generally includes placing blocks of burrito filling on flat tortillas at station 102, and pushing both the blocks of burrito filling backwards into flights 104 on a horizontal belt 106 to fold a leading edge of the tortilla. In particular, the fold of each leading tortilla edge is formed by pushing the tortilla backwards on a flighted belt so that it conforms to the shape of a C-shaped flight 104. This is done at the same time a block of burrito filling is placed onto the tortilla.

Next, lead-in bars 110 crease the leading edge fold of the tortilla down along each side of the burrito filling. Then, each tortilla is contacted by ploughs 112 to fold up the two sides of the tortilla. The side folds are over the top of the flights 104 on the belt so the burritos can be removed either by passing the folded burritos onto a faster conveyor or by physically pulling them forward off the belt with grippers.

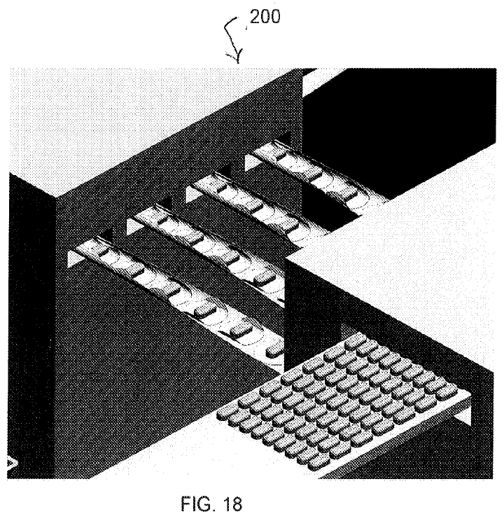

Another aspect of an automated burrito maker 200 is illustrated in FIG. 18. In this aspect, tortillas with patties or blocks of burrito filling placed on them are conveyed on an initially flat first garniture belt. The belt shape then changes and wraps around the burrito filling to form one or two end folds on the tortilla. The end folds are held down by a plate above the folded portion of the tortilla while the tortillas are transferred onto a transverse belt, keeping their original orientation. A second garniture belt then simultaneously forms two side folds in the same way. The end folds are held down by a bar above until the first side fold has been completed to hold the end folds down.

The present invention has now been described with reference to several embodiments or aspects thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments or aspects described without departing from the scope of the invention. Thus, the scope of the present invention should not be limited to the structures described herein, but only by the structures described by the language of the claims and the equivalents of those structures.

1. An automated burrito maker for forming burritos from a flexible tortilla comprising an upper surface, a leading edge, a trailing edge, a first side, and a second side, the automated burrito maker comprising:
a filling station for providing a quantity of burrito filling on the upper surface of the tortillas, the filling station comprising a first generally horizontal belt having an upper surface for conveying tortillas in a machine direction;
an air blast station comprising a second generally horizontal belt that is spaced by a gap from the first horizontal belt, and an air supply positioned below the gap for delivering an air blast to lift the leading edge of each tortilla as each tortilla is conveyed in the machine direction from the first horizontal belt toward the second horizontal belt and over the gap;
a front fold station comprising upper rollers and crimping rails for crimping the leading edge of the tortilla toward the upper tortilla surface and around at least a portion of the burrito filling;
a first side fold station comprising a first folding rail for guiding the first side of the tortilla to wrap over at least a portion of the burrito filling; and
a second side fold station comprising a second folding rail for guiding the second side of the tortilla to wrap over at least a portion of the burrito filling and at least a portion of the first side of the tortilla.

2. The automated burrito maker of claim 1, wherein the filling station comprises an angled conveyor positioned above the horizontal belt for moving the quantity of burrito filling toward the upper surface of the tortillas.

3. The automated burrito maker of claim 1, wherein the quantity of burrito filling is provided as multiple discrete blocks that each comprise multiple burrito ingredients.

4. The automated burrito maker of claim 3, wherein the multiple burrito ingredients comprise a binding agent.

5. The automated burrito maker of claim 3, further comprising a block-forming station in which the burrito ingredients are subjected to sufficient pressure to form discrete blocks.

6. The automated burrito maker of claim 5, further comprising a freezing station after the block-forming station for freezing the discrete blocks after the pressure is removed.

7. The automated burrito maker of claim 1, wherein the air supply comprises a plurality of air jets spaced from each other in a direction transverse to the machine direction.

8. The automated burrito maker of claim 1, further comprising a plurality of rollers vertically spaced from the second horizontal belt after the air blast station, wherein the lifted leading edge of each tortilla will contact the plurality of rollers as it moves from the air blast station toward the front fold station.

9. The automated burrito maker of claim 1, wherein at least one of the first folding rail and the second folding rail are curved from one side of the second horizontal belt toward the opposite side of the second horizontal belt.

10. The automated burrito maker of claim 2, wherein the angled conveyor and the first horizontal belt are synchronized for precise depositing of the burrito filling on a predetermined location of the upper surface of each tortilla.

11. A method of forming burritos using an automated burrito maker, comprising the steps of:
placing a flexible tortilla on an upper surface of a first conveyor, wherein each tortilla comprises an upper surface, a leading edge, a trailing edge, a first side, and a second side;
conveying each tortilla in a machine direction to a filling station;
placing a quantity of burrito filling on the upper surface of each tortilla;
conveying each tortilla toward an air blast station that comprises a second conveyor that is spaced by a gap from the first conveyor, and an air supply positioned below the gap;
delivering an air blast to lift the leading edge of each tortilla as each tortilla is conveyed in the machine direction from the first conveyor toward the second conveyor and over the gap;
conveying each tortilla to a front fold station comprising upper rollers and crimping rails;
crimping the leading edge of each tortilla toward the upper tortilla surface and around at least a portion of the burrito filling;
conveying each tortilla to a first side fold station comprising a first folding rail;
guiding the first side of each tortilla over at least a portion of the burrito filling;
conveying each tortilla to a second side fold station comprising a second folding rail; and
guiding the second side of the tortilla over at least a portion of the burrito filling and at least a portion of the first side of the tortilla.

12. The method of claim 11, wherein the filling station comprises an angled conveyor positioned above the horizontal belt, and wherein the angled conveyor moves the quantity of burrito filling toward the upper surface of each tortilla.

13. The method of claim 11, wherein the step of placing a quantity of burrito filling on each tortilla comprises providing the quantities of burrito filling in discrete blocks that each comprise multiple burrito ingredients.

14. The method of claim 13, wherein the multiple burrito ingredients comprise a binding agent.

15. The method of claim 13, further comprising a step of forming the quantities of burrito filling into discrete blocks before the step of placing the burrito filling on the upper surface of each tortilla by subjecting the quantities of burrito filling to sufficient pressure to form discrete blocks.

16. The method of claim 15, further comprising a step of freezing the discrete blocks at a freezing station after the pressure is removed.

17. The method of claim 11, wherein the step of delivering an air blast comprises providing an air blast from a plurality of air jets spaced from each other in a direction transverse to the machine direction.

18. The method of claim 11, wherein a plurality of rollers is vertically spaced from the second horizontal belt after the air blast station, wherein the lifted leading edge of each tortilla contacts the plurality of rollers as it moves from the air blast station toward the front fold station.

19. The method of claim 11, wherein at least one of the first folding rail and the second folding rail are curved from one side of the second horizontal belt toward the opposite side of the second horizontal belt.

20. The method of claim 12, wherein the angled conveyor and the first horizontal belt are synchronized for precise depositing of the burrito filling on a predetermined location of the upper surface of each tortilla.

21. An automated wrap maker for forming wrap-type food products from a flexible wrap material comprising an upper surface, a leading edge, a trailing edge, a first side, and a second side, the automated wrap maker comprising:
a filling station for providing a quantity of filling on the upper surface of the wrap material, the filling station comprising a first generally horizontal belt having an upper surface for conveying the wrap material in a machine direction;
an air blast station comprising a second generally horizontal belt that is spaced by a gap from the first horizontal belt, and an air supply positioned below the gap for delivering an air blast to lift the leading edge of the wrap material as the wrap material is conveyed in the machine direction from the first horizontal belt toward the second horizontal belt and over the gap;
a front fold station comprising upper rollers and crimping rails for crimping the leading edge of the wrap material toward the upper wrap material surface and around at least a portion of the filling;
a first side fold station comprising a first folding rail for guiding the first side of the wrap material to wrap over at least a portion of the filling; and
a second side fold station comprising a second folding rail for guiding the second side of the wrap material to wrap over at least a portion of the filling and at least a portion of the first side of the wrap material.

22-30. (canceled)

31. A method of forming wrap-type food products using an automated wrap maker, comprising the steps of:
placing a flexible wrap material on an upper surface of a first conveyor, wherein the wrap material comprises an upper surface, a leading edge, a trailing edge, a first side, and a second side;
conveying the wrap material in a machine direction to a filling station;
placing a quantity of filling on the upper surface of the wrap material;
conveying the wrap material toward an air blast station that comprises a second conveyor that is spaced by a gap from the first conveyor, and an air supply positioned below the gap;
delivering an air blast to lift the leading edge of the wrap material as the wrap material is conveyed in the machine direction from the first conveyor toward the second conveyor and over the gap;
conveying the wrap material to a front fold station comprising upper rollers and crimping rails;
crimping the leading edge of the wrap material toward the upper wrap material surface and around at least a portion of the filling;
conveying the wrap material to a first side fold station comprising a first folding rail;
guiding the first side of the wrap material over at least a portion of the filling;
conveying the wrap material to a second side fold station comprising a second folding rail; and
guiding the second side of the wrap material over at least a portion of the filling and at least a portion of the first side of the wrap material.

32-40. (canceled)
